(19) United States
(12) Patent Application Publication
(10) Pub. No.: US 2020/0210555 A1
(43) Pub. Date: Jul. 2, 2020

(54) Information Processing Method, Hidden Information Parsing and Embedding Method, Apparatus, and Device

(71) Applicant: Alibaba Group Holding Limited, Grand Cayman (KY)

(72) Inventor: Yongliang Liu, Hangzhou (CN)

(21) Appl. No.: 16/711,366

(22) Filed: Dec. 11, 2019

(30) Foreign Application Priority Data
Dec. 27, 2018 (CN) 201811609458.1

(51) Int. Cl. G06F 21/16; G06F 21/64; G06F 21/60

(52) U.S. Cl. CPC G06F 21/16; G06F 21/602; G06F 21/64

(57) ABSTRACT

An information processing method is disclosed. The method includes: obtaining a carrier object; obtaining notification information for embedded hidden information in the carrier object, the notification information being used for instructing a hidden information embedding end to parse attributes of at least a part of the embedded hidden information in the carrier object, and embed new hidden information according to the attributes, without modifying the embedded hidden information; and embedding the new hidden information in the carrier object without modifying the embedded hidden information based on the notification information. Using the method, the problem that embedded hidden information may be changed when hidden information is entered in cases of multi-level and/or multi-channel information hiding is solved.

### CROSS REFERENCE TO RELATED PATENT APPLICATIONS

This application claims priority to Chinese Patent Application No. 201811609458.1, filed on 27 Dec. 2018 and entitled “Information Processing Method, Hidden Information Parsing and Embedding Method, Apparatus, and Device,” which are hereby incorporated by reference in its entirety.

### TECHNICAL FIELD

The present disclosure relates to the technical field of computers, and particularly to information processing methods, apparatuses, electronic devices, and storage devices, and hidden information parsing methods, apparatuses, electronic devices, and storage devices. The present disclosure further relates to hidden information embedding methods

### BACKGROUND

Data is a valuable and important asset for companies that provide data-driven services. A data leakage may bring economic losses and declines in reputation, and may even bring catastrophic consequences to the companies. Therefore, data security is critical to these companies. Information hiding (a watermarking technology is an information hiding technology) is a technology used for tracing data leakages, and is the last link of a data security system, which enables a data leakage party to be traced after a leakage is discovered, thereby deterring malicious data leakages.

In information hiding applications, in many cases, multiple pieces of hidden information are needed to be embedded into a carrier object. For example, a carrier object may have copyright (or ownership information), data tracking and traceability information, fragile watermark information used for content integrity authentication, or tag information of the carrier object (i.e., multiple pieces of hidden information of multiple functions, hereinafter referred to as multi-functional information hiding). Furthermore, multiple pieces of hidden information used for a same function, such as multiple pieces of information used for data tracking and traceability (B's identity-related information is embedded when distributing to B from A, and C's identity-related information may further be embedded when further distributing to C from B) may exist. Multiple pieces of hidden information in this case are referred to as multi-level information hiding. For example, an embedding party may not know how many levels are currently embedded when embedding multiple levels of traceable hidden information. Without any knowledge, a piece of information embedded thereby at will is very likely to cover or destroy previously embedded information, thus losing the meaning of multi-level traceability (destroying the purpose of multi-level traceability). The same is true for multi-functional information hiding. Without knowing what type of hidden information is currently embedded, hidden information embedded by an embedding party is very likely to destroy hidden information that is embedded previously.

In short, in cases of multi-level and/or multi-channel information hiding, a problem of modifying embedded hidden information when hidden information is embedded exists.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides an information processing method to solve the problem of potentially modifying embedded hidden information when hidden information is embedded in cases of multi-level and/or multi-channel information hiding.

The present disclosure provides an information processing method, which is applied in a first information embedding end. The method includes:

generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

sending the notification information.

In implementations, sending the notification information includes transmitting the notification information as a separate message, the notification information being associated with the carrier object.

In implementations, one carrier object is included, and the notification information includes:

a type of the embedded hidden information; and

description information of the embedded hidden information.

In implementations, at least two carrier objects are included, and sending the notification information includes: sending a separate piece of notification information to each carrier object, the notification information including a type of the embedded hidden information, and description information of the embedded hidden information.

In implementations, the at least two carrier objects are included, and sending the notification information includes sending a single piece of notification information to the at least two carrier objects.

In implementations, when multiple carrier objects that are simultaneously sent are embedded with hidden information, the notification information includes:

a type of the embedded hidden information; and

description information of the embedded hidden information.

In implementations, when multiple carrier objects that are simultaneously sent include both a carrier object that is not embedded with hidden information and a carrier object that is embedded with hidden information, the notification information includes:

identification information that is used for indicating whether hidden information has been embedded in the carrier object;

a type of the embedded hidden information; and

description information of the embedded hidden information.

In implementations, the method further includes: embedding the notification information into the carrier object, wherein sending the notification information includes sending the carrier object.

In implementations, the notification information includes:

identification information that is used for indicating whether hidden information has been embedded in the carrier object;

a type of the embedded hidden information; and

description information of the embedded hidden information.

In implementations, the notification information includes hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information;

description information of the embedded hidden information.

In implementations, the type of the embedded hidden information includes at least one of the following types:

a copyright type of hidden information;

a numerical type of hidden information;

a structural type of hidden information; and

an annotation type of hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, the notification information further includes at least one of the following information:

starting prefix information, the starting prefix information being used for indicating whether hidden information has been embedded in the carrier object or used for marking a starting position of at where the embedded hidden information is embedded in the carrier object;

a capacity type of hidden information that can be embedded;

length information of hidden information metadata;

verification information for the notification information.

In implementations, the capacity type is determined according to a file type of the carrier object.

In implementations, embedding the notification information into the carrier object includes:

embedding notification information in a binary data format or notification information in a hexadecimal data format into the carrier object.

In implementations, the embedded hidden information is embedded digital watermark information, and the new hidden information is new digital watermark information.

The present disclosure also provides a method for parsing hidden information, which includes:

obtaining a carrier object;

obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

In implementations, parsing the embedded hidden information from the carrier object based on the notification information includes:

determining whether embedded hidden information exists in the carrier object; and

parsing the embedded hidden information is parsed from the carrier object based on the notification information if affirmative.

In implementations, obtaining the notification information for the embedded hidden information in the carrier object includes:

obtaining the notification information that exists as a separate message; or

extracting the notification information from the carrier object.

In implementations, parsing the embedded hidden information from the carrier object based on the notification information includes:

converting notification information in a hexadecimal data format into notification information in a binary data format; and

parsing the embedded hidden information from the carrier object according to the notification information in the binary data format.

In implementations, the notification information includes: hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information; and

description information of the embedded hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, parsing the embedded hidden information from the carrier object based on the notification information includes:

parsing the hidden information from the carrier object based on description information of the embedded hidden information.

The present disclosure also provides a method for embedding hidden information, which includes:

obtaining a carrier object;

obtaining notification information for embedded hidden information in the carrier object, the notification information being used for instructing a hidden information embedding end to parse attributes of all the embedded hidden information in the carrier object, and embed new hidden information according to the attributes, without modifying the embedded hidden information; and

embedding the new hidden information in the carrier object without modifying the embedded hidden information based on the notification information.

In implementations, embedding the new hidden information in the carrier object without modifying the embedded hidden information based on the notification information includes:

determining a first location in which the embedded hidden information is embedded in the carrier object based on the notification information; and

embedding the new hidden information in a second location of the carrier object that is different from the first location.

In implementations, embedding the new hidden information in the carrier object without modifying the embedded hidden information based on the notification information includes:

determining a first channel used by the embedded hidden information when being embedded in the carrier object based on the notification information;

embedding the new hidden information in the carrier object through a second channel that is different from the first channel.

The present disclosure further provides an information processing apparatus, which is applied in a first information embedding end, and includes:

a notification information generating unit configured to generate notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and a notification information sending unit configured to send the notification information.

The present disclosure also provides an electronic device, which includes:

processor(s);

memory configured to store a program of an information processing method, wherein the device, after being powered on and running the program of the information processing method through the processor(s), performs the following operations:

generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

sending the notification information.

The present disclosure also provides a storage device that stores a program of an information processing method, the program being executed by a processor to perform the following operations:

generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

sending the notification information.

The present disclosure also provides an apparatus for parsing hiding information, which includes:

a carrier object acquisition unit configured to obtain a carrier object;

a notification information acquisition unit configured to obtain notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

a hidden information extraction unit configured to parse the embedded hidden information from the carrier object based on the notification information.

The present disclosure also provides an electronic device, which includes:

processor(s);

memory configured to store a program of a hidden information parsing method, wherein the device, after being powered on and running the program of the information processing method through the processor(s), performs the following operations:

obtaining a carrier object;

obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

The present disclosure also provides a storage device that stores a program of a hidden information parsing method, the program being executed by a processor to perform the following operations:

obtaining a carrier object;

obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

Compared with existing technologies, the present disclosure has the following advantages:

The information processing method, apparatus, electronic device and storage device provided by the present disclosure generate and transmit notification information for hidden information embedded in a carrier object, the notification information being used for instructing a receiving end to parse attributes of all the hidden information embedded in the carrier object, or used for instructing a second information embedding end to parse the attributes of all the hidden information embedded in the carrier object, and embed new hidden information according to the attributes, without modifying the embedded hidden information, thus solving the problem that embedded hidden information may be changed when hidden information is entered in cases of multi-level and/or multi-channel information hiding.

### BRIEF DESCRIPTION OF THE DRAWINGS

FIG. 1 is a flowchart of an information processing method according to a first embodiment of the present disclosure.

FIG. 2 is a schematic diagram of a format of notification information of embedded hidden information according to the first embodiment of the present disclosure.

FIG. 3 is a flowchart of generating notification information for embedded hidden information in a carrier object according to the first embodiment of the present disclosure.

FIG. 4 is a flowchart of determining hidden information metadata according to the first embodiment of the present disclosure.

FIG. 5 is a flowchart of determining description information of embedded hidden information according to the first embodiment of the present disclosure.

FIG. 6 is a flowchart of a method for parsing hidden information according to a second embodiment of the present disclosure.

FIG. 7 is a flowchart of a method for embedding hidden information according to a third embodiment of the present disclosure.

FIG. 8 is a schematic diagram of an information processing apparatus according to a fourth embodiment of the present disclosure.

FIG. 9 is a schematic diagram of an electronic device according to a fifth embodiment of the present disclosure.

FIG. 10 is a schematic diagram of an apparatus for parsing hidden information according to a seventh embodiment of the present disclosure.

FIG. 11 is a schematic diagram of an electronic device according to an eighth embodiment of the present disclosure.

### DETAILED DESCRIPTION

A number of specific details are set forth in the description hereinafter in order to provide a thorough understanding of the present disclosure. However, the present disclosure can be implemented in many other ways that are different from those described herein. One skilled in the art can make a similar promotion without departing from the spirit of the disclosure. Therefore, the disclosure is not limited by the specific embodiments disclosed herein.

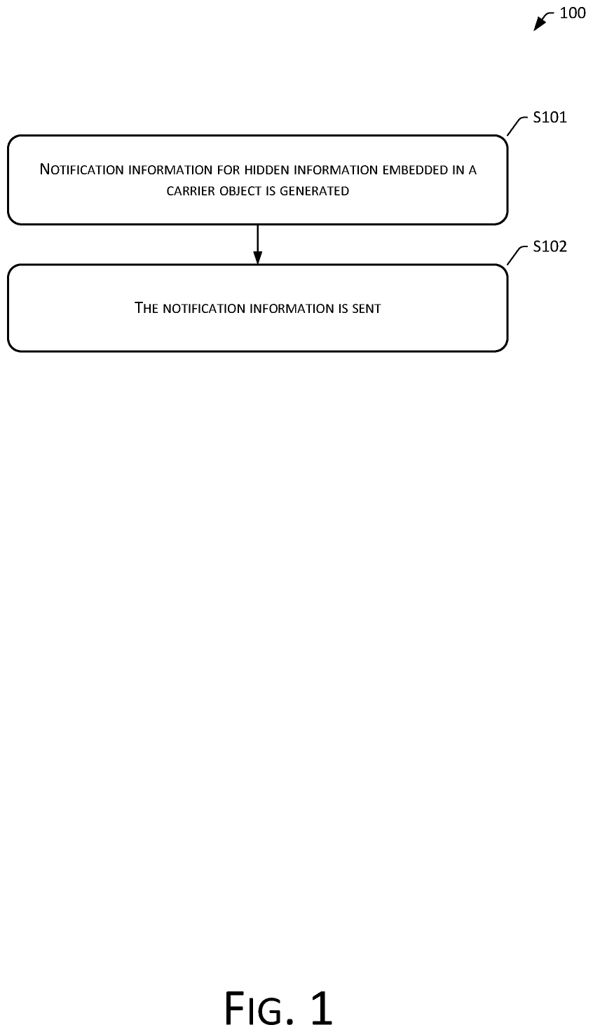

A first embodiment of the present disclosure provides an information processing method, which is applied in a first information embedding end (a computing device in which hidden information is embedded into a carrier object). A detailed description is provided hereinafter with reference to FIGS. 1-4.

As shown in FIG. 1, at operation S101, notification information for hidden information embedded in a carrier object is generated, the notification information is used to instruct a receiving end to parse attributes of all the hidden information embedded in the carrier object, or used to instruct a second information embedding end to parse the attributes of all the hidden information embedded in the carrier object, and embed new hidden information according to the attributes, without modifying the embedded hidden information.

The receiving end refers to a peer computing device that receives the carrier object. The receiving end may parse out the attributes of all the hidden information embedded in the carrier object according to the notification information.

The second information embedding end refers to a computing device that obtains the carrier object from the first information embedding end and then embeds the new hidden information.

The hidden information refers to additional information added to the carrier object. The additional information has a specific meaning. The carrier object may be a word document, a PDF document, an Excel file, etc. Adding appropriate hidden information into the carrier object can prevent data leakage and protect data security. For example, adding copyright information as a watermark in a word document can prevent piracy. The hidden information includes a digital watermark. The embedded hidden information is embedded digital watermark information, and the new hidden information is new digital watermark information.

It should be noted that “without modifying the embedded hidden information” refers to completely retaining the embedded hidden information, which includes not covering or destroying the embedded hidden information. “Without modifying the embedded hidden information” does not mean that no operation can be performed on the embedded hidden information. When new hidden information is embedded, a location of the embedded hidden information may be moved, but the integrity of the embedded hidden information cannot be destroyed. The integrity of the embedded hidden information needs to be maintained.

The attributes of the embedded hidden information includes a type of the embedded hidden information, an amount of the embedded hidden information, an embedded location of the embedded hidden information in the carrier object, etc.

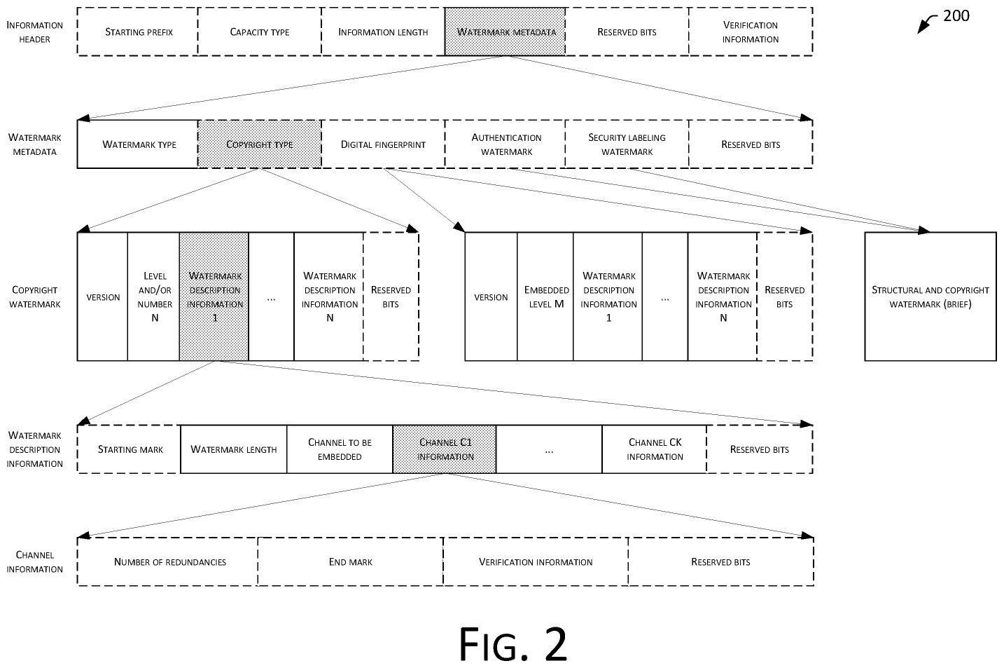

The notification information includes hidden information metadata. The hidden information metadata is used to describe attribute(s) of the embedded hidden information. FIG. 2 is a schematic diagram of a format 200 of notification information for embedded hidden information.

The hidden information metadata includes at least one of the following types: a type of the embedded hidden information, an order in which the embedded hidden information is embedded in the carrier object, a level of the embedded hidden information, and an amount of the embedded hidden information, and description information of the embedded hidden information.

The order in which the embedded hidden information is embedded in the carrier object may be referred to as an access version of the hidden information. If the number of versions is no more than 16, an access version of hidden information may be represented by four bits. An initial version of hidden information is 0000. For example, if two embedding of hidden information has been performed before the embedded hidden information, an access version of the embedded hidden information is 3, and is denoted as 0011.

The type of the embedded hidden information includes at least one of the following types: a copyright type of hidden information; a digital type of hidden information; a structural type of hidden information; and a label type of hidden information.

Different service scenarios adapt to different types of hidden information, which specifically include copyright watermarks, digital fingerprints, authentication watermarks, security labeling watermarks, etc. A copyright watermark is mainly used for copyright protection of digital media. A digital fingerprint is mainly used for traceability issues in a data flow topology. If the number of watermark types is at most 8, 8 bits can then be used to indicate whether it is such a type. A plurality of watermark types can be simultaneously included in a single carrier object.

The notification information may include a level and an amount of the embedded hidden information. If the watermark type is digital fingerprint multi-level information hiding, multiple levels of hidden information have been embedded the carrier object when the carrier object is transmitted to a current node. In order to enable traceability of the hidden information, these pieces of hidden information need to be embedded in an order of access. Therefore, the upper level is also very important information. If the watermark type is a copyright watermark and the carrier object may have multiple pieces of copyright information, these pieces of information are of a same level if having the same author. If the copyright information has an order of sequence, these pieces of information are similar to the digital fingerprint multi-level watermark, having distinct levels.

The description information of the embedded hidden information may include length information of the embedded hidden information, information of a channel in which the embedded hidden information is embedded in the carrier object, embedding end identification information of the embedded hidden information, a number of times that the embedded hidden information is redundantly embedded in the channel, etc.

The length information of the embedded hidden information may be the number of bits included in the embedded hidden information after the embedded hidden information is encoded. For example, the embedded hidden information is a bit sequence of “0111101100”, and the length of the embedded hidden information is 10 bits.

The information of the channel in which the hidden information is embedded in the carrier object may refer to a manner of embedding the hidden information in the carrier object, and may also refer to a manner of embedding the description information of the hidden information in the carrier object. Therefore, a channel through which the hidden information is embedded in the carrier object may refer to a channel through which the hidden information is embedded, or a channel through which the description information of the hidden information is embedded. The embedded channel is related to a type of the carrier object. For example, a word document can use different ways of embedding hidden information, such as character color, character spacing, character position up and down, character size, etc. The embedded channel is also related to characteristics of the hidden information or the description information of the hidden information that is embedded in the carrier object.

As an embodiment, the channel in which the hidden information is embedded in the carrier object may refer to a location in which the description information of the hidden information or the hidden information is embedded in the carrier object and an embedding means. For example, in a word file, description information of hidden information or the hidden information is embedded in one paragraph according to certain character spacing, and the description information of the hidden information or the hidden information is embedded in another paragraph according to the character spacing or other forms.

The embedding end identification information of the embedded hidden information may refer to embedding end identification information of the embedded hidden information in one time. The purpose of adding the embedding end identification information of the embedded hidden information in the description information of the embedded hidden information is to maintain synchronization information of the embedded hidden information. For example, hidden information is embedded for 5 times through a channel. However, a part of data of the channel is deleted (or a corresponding image is cut or translated). If no ending mark for each hidden information that is embedded exists, hidden information that is embedded subsequently and redundantly will be considered as hidden information that is currently embedded, thus losing information synchronization and possibly leading to a complete failure of extraction. This error can be avoided by adding embedding end identification information of the embedded hidden information. If the length of hidden information in a single embedding is 100 bits, embedding end identification information of the embedded hidden information in one time is a bit sequence of 16 consecutive 0s (the probability of collision is one and a half out of one hundred thousand, which is very small), i.e., “0000110000110000110000”. Before the consecutive 16 zeros are encountered, if the number of extracted bits is less than 100 bits, data is considered to be corrupted, and currently extracted watermark information is discarded. Extraction is restarted after 16 0s.

The number of times that the embedded hidden information is redundantly embedded in the channel may refer to the number of times of redundant embedding in all channels, or may refer to the number of times of redundant embedding in a certain channel or in each channel. In order to increase the robustness and anti-attack capability of hidden information embedding solutions, the number of times that the hidden information is redundantly embedded in the channel can be determined according to actual needs.

The notification information further includes at least one of the following: starting prefix information, a type capacity of hidden information that can be embedded, length information of the hidden information metadata, and verification information.

The starting prefix information is used to indicate whether hidden information has been embedded in the carrier object, or is used to mark a starting position at which the hidden information is embedded in the carrier object. A starting prefix is mainly used to notify whether hidden information is embedded in a current carrier object, thus avoiding a false extraction when a carrier object does not have any hidden information embedded. In addition, when an in-band transmission mode is selected (indication information is embedded in the carrier object together with the hidden information), the starting prefix may mark a starting position of the embedded hidden information for distinguishing the indication information from a data body of the carrier object. The starting prefix is usually defined as a continuous 1, 0, or a 0-1 sequence with certain regularity, to reduce the probability of collision. For example, starting prefix information is defined as “0000000000000001”, which represents that hidden information has been embedded currently and this position is the beginning of the hidden information, and the probability of collision is 1/216.

A consideration is made as to whether an embeddable capacity of the carrier matches a capacity of the hidden information. Capacity types of hidden information that is embeddable in different types of carrier objects are different. For example, a capacity type of embeddable hidden information of a word document type of carrier object can be considered as no limit, and an embeddable capacity of a picture type of carrier object is related to the resolution of a picture itself. A capacity type of embeddable hidden information can be represented by 1 bit, 1 means an unlimited capacity, and 0 means a limited capacity. For example, if it is a word document, it can be considered that there is no upper limit for the capacity of hidden information that is embedded, and a capacity type of embeddable hidden information can be represented by 1.

The number of bits of the length information of the hidden information metadata can be determined according to the length of the hidden information metadata. If the length of the hidden information metadata is not more than 256 bits, the number of bits of the length information of the hidden information metadata is fixed to be 8 bits. For example, if the length of the hidden information metadata is 64 bits, the length information of the hidden information metadata is then “01000000”. For another example, if the length of the hidden information metadata is not more than 400 bits, as few as 9 bits can be used for description. If the length of the information metadata is 200 bits, the length information of the hidden information metadata can be expressed as “011001000”.

In order to increase the fault tolerance of data streams, the notification information may further include verification information. The verification information may be a check code of a fixed length (generally 32 bits). The verification information can be set at the end of a data stream of the notification information.

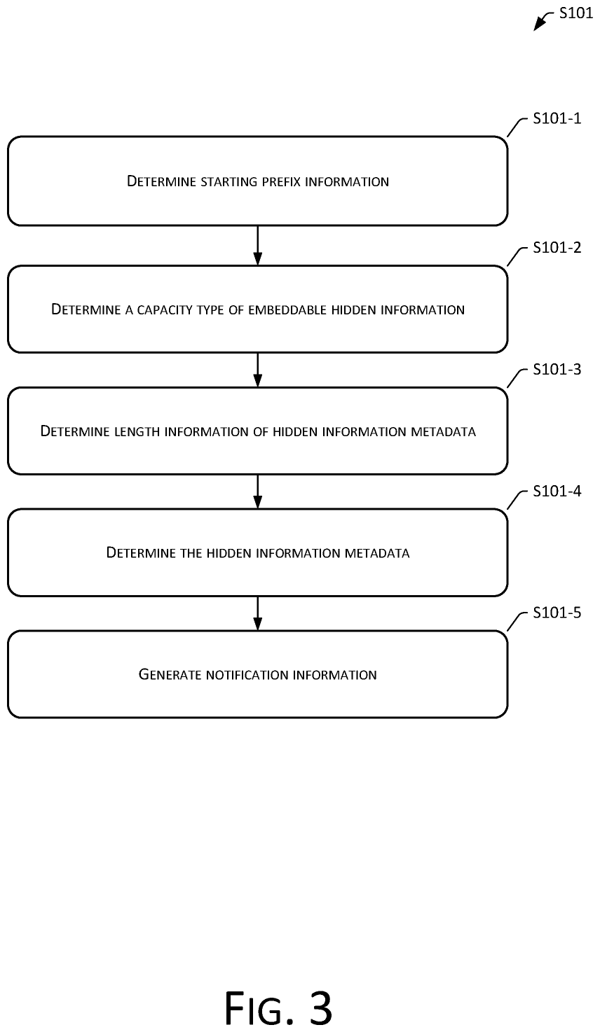

As shown in FIG. 3, generating notification information for embedded hidden information in a carrier object (i.e., the operation S101 as shown FIG. 1) may include the following operations.

Operation S101-1: Determine starting prefix information.

Operation S101-2: Determine a capacity type of embeddable hidden information.

Operation S101-3: Determine length information of hidden information metadata.

Operation S101-4: Determine the hidden information metadata.

Operation S101-5: Generate notification information.

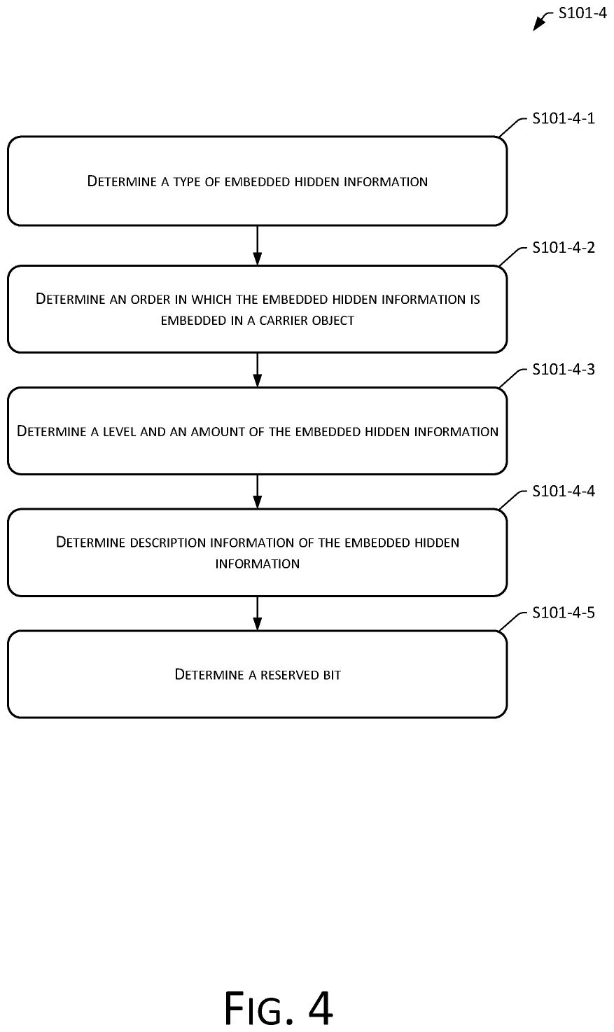

As shown in FIG. 4, determining hidden information metadata (i.e., the operation S101-4 as shown FIG. 3) may include the following operations.

Operation S101-4-1: Determine a type of embedded hidden information.

Operation S101-4-2: Determine an order in which the embedded hidden information is embedded in a carrier object.

Operation S101-4-3: Determine a level and an amount of the embedded hidden information.

Operation S101-4-4: Determine description information of the embedded hidden information.

Operation S101-4-5: Determine a reserved bit.

It should be noted that the reserved bit may be set to have a fixed length in order to enhance fault tolerance, and the length of the reserved bit may be calculated according to a length of preset indication information and a length of other information of the indication information. For example, if the length of the preset indication information is 256 bits and the length of other information of the indication information is 240 bits, the length of the reserved bits is 16 bits.

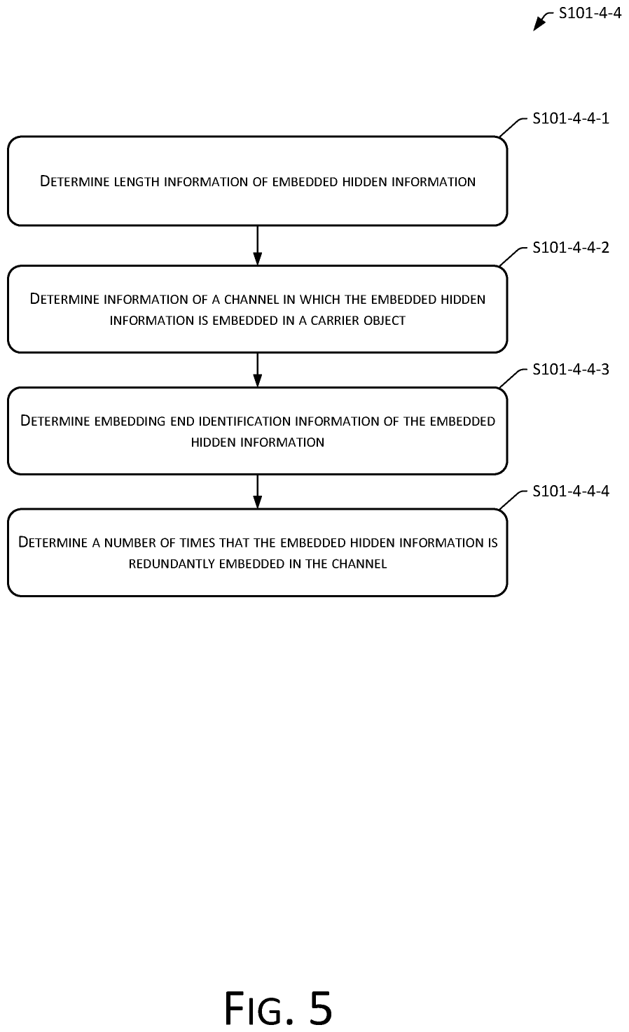

As shown in FIG. 5, determining description information of embedded hidden information (i.e., the operation S101-4-4 as shown FIG. 4) may include the following operations.

Operation S101-4-4-1: Determine length information of embedded hidden information.

Operation S101-4-4-2: Determine information of a channel in which the embedded hidden information is embedded in a carrier object.

Operation S101-4-4-3: Determine embedding end identification information of the embedded hidden information.

Operations S101-4-4-4: Determine a number of times that the embedded hidden information is redundantly embedded in the channel.

It should be noted that generating the notification information for the embedded hidden information in the carrier object as described in the foregoing is only an embodiment. In a specific implementation, some of the foregoing operations may be included, or other operations may be included.

An example of a process of generating notification information for embedded hidden information in a carrier object is described hereinafter.

User 1 downloads a word document from a Ding drive, and desires to embed a hidden information ID value “13230” therein. Using a certain encoding method, if hidden information is a 0, 1 sequence of “0111101100” having a length of 10 bits after encoding, and a digital fingerprint watermark is embedded, a process of generating indication information transmitted from User 1 to User 2 according to the above information is given as follows.

1. Determine starting prefix information. The starting prefix information may be defined as “0000000000000001”, which represents that embedded watermark information currently exists and this location is the beginning of watermark information, and the probability of collision is ½\hat{ }16.

2. Determine a capacity type of hidden information that can be embedded. Since it is a word document, it can be considered that there is no upper limit for the embedded capacity, and the capacity bit is 1.

3. Determine length information of hidden information metadata. If a length of watermark metadata does not exceed 400 bits, as few as 9 bits can be used for description. For example, if the length is 200, the length information of the hidden information metadata can be determined as “011001000”.

4. Determine the hidden information metadata.

a. Determine a hidden information type. Due to the complexity of a multi-level and multi-functional information hiding system, multiple types of watermarks may exist in a same carrier object. If eight types of watermarks exist, an order is shown in the following table. Case 1 assumes that a type of hidden watermark is a digital fingerprint, and Case 2 assumes that both a digital watermark and an annotated watermark exist. In this case, bit representations are shown in the table below.

TABLE 1

| | Watermark Type | | | | | | | |
|---|---|---|---|---|---|---|---|---|
| | Copyright | Digital | Structural | Label | xx | xx | xx | xx |
| | Watermark | Fingerprint | Watermark | Watermark | Watermark | Watermark | Watermark | Watermark |
| Case 1 Bit | 0 | 1 | 0 | 0 | 0 | 0 | 0 | 0 |
| Representation | | | | | | | | |
| Case 2 Bit | 0 | 1 | 0 | 1 | 0 | 0 | 0 | 0 |
| Representation | | | | | | | | |

The hidden information type is determined to be a digital fingerprint, and information of the hidden information type is “01000000”.

b. Determine an order in which embedded hidden information is embedded in a carrier object. If the number of access versions does not exceed a maximum of 16 versions, an access version can be represented by 4 bits. Information of the order in which the embedded hidden information is embedded in the carrier object is determined to be “0000”.

c. Determine a level and a number of the embedded hidden information. For digital fingerprints, the level and the number are generally the same. This value depends on how many users have propagated the carrier object before. If the number of users in the system does not exceed 64, it is sufficient to use 6 bits. If User 1 is a user who originally obtained carrier data, a determination is made that the level of the embedded hidden information is 000000.

d. Determine description information of the embedded hidden information.

1) Determine length information of the embedded hidden information. The hidden information ID value “13230” is encoded using a certain encoding method. If the length of the hidden information is 0, 1 sequence “0111101100” of 10 bits after encoding, the hidden information actually embedded is “0111101100” in this case. The length of the hidden information is determined to be 10 bits, which can be expressed as “001010”.

2) Determine information of a channel in which the embedded hidden information is embedded in the carrier object. If at most 15 embedded channels are included (or used), 4 bits are used to describe how many embedded channels are used, and then corresponding bit sequences are used to describe which channels are specifically used. In this example, a total of 4 channels are used, and they are exactly the first 4 channels. Therefore, the following information can be used to describe the channel information: 0100∥0001∥0010∥0011∥0100, where the symbol “∥” represents cascading.

3) Determine embedding end identification information of the embedded hidden information. An embedding end mark of embedded hidden information in a single attempt is defined as a sequence of 16 consecutive 0 bits, i.e., “0000110000110000110000”. The probability of collision (i.e., not a true end mark but mistakenly considered as the end mark) is one and a half out of one hundred thousand.

4) Determine the number of times that the embedded hidden information is redundantly embedded in the channel. If a maximum number of redundant embeddings is 7 times, 3 bits can be used to describe the number of embeddings. A current number of redundant embeddings is 0, i.e., no redundancy exists. A successive three 0's can be used for description, i.e., “000”.

Based on the above operations, the description information of the embedded hidden information that is finally generated is:

“001010∥0100∥0001∥0010∥001∥10100∥0000000000000000∥000”

The embedded hidden information is “0111101100”, where the length information of the embedded hidden information is: 001010; the information of the channel in which the embedded hidden information is embedded in the carrier object is: 0100∥0001∥0010∥0011∥0100; the embedding end identification information of the embedded hidden information is: 0000000000000000; and the number of times that the embedded hidden information is redundantly embedded in the channel is: 000.

5. Determine a reserved position. In order to ensure a fixed length of information header data, reserved bits are set to have a fixed length, which can be set to 3^{˜}5 bits, and initialized to be 00000.

In summary, Table 2 is a brief description of notification information. According to this table, a data stream of the notification information that is finally generated in a hexadecimal format is “000132100002412340000000000000”.

TABLE 2
Description
Header Data in

| Hexadecimal | Starting Prefix | | | | | | | | | | | | | | | |
|---|---|---|---|---|---|---|---|---|---|---|---|---|---|---|---|---|
| Format | 0 | | | | 0 | | | | 0 | | | | 0 | | | |
| Header Data in | 0 | 0 | 0 | 0 | 0 | 0 | 0 | 0 | 0 | 0 | 0 | 0 | 0 | 0 | 0 | 1 |
| Binary Format | | | | | | | | | | | | | | | | |

| Capacity | | | | | | | | | | | | | | | | | | | | | | | | | | | |
|---|---|---|---|---|---|---|---|---|---|---|---|---|---|---|---|---|---|---|---|---|---|---|---|---|---|---|---|
| Type | Information Length | | | | | | | | | Watermark Type | | | | | | | | Version | | | | Embedded level | | | | | |
| 3 | | | | 2 | | | | 1 | | | | 0 | | | | 0 | | | | 0 | | | | 0 | | | |
| 0 | 0 | 1 | 1 | 0 | 0 | 1 | 0 | 0 | 0 | 0 | 1 | 0 | 0 | 0 | 0 | 0 | 0 | 0 | 0 | 0 | 0 | 0 | 0 | 0 | 0 | 0 | 0 |

| Watermark Type Length | | | | | | . . . |
|---|---|---|---|---|---|---|
| 2 | | | | | | . . . |
| 0 | 0 | 1 | 0 | 1 | 0 | . . . |

This operation generates the notification information for the embedded hidden information in the carrier object, and provides a precondition for sending the notification information at operation S102.

As shown in FIG. 1, at operation S102, the notification information is sent.

Sending the notification information may refer to sending the notification information to a peer computing device. The peer computing device may embed new hidden information or may not embed new hidden information but send the carrier object including the hidden information to a next computing device.

Two manners of sending the notification information may exist: an in-band mode (embedding the notification information together with the hidden information in the carrier object) and an out-of-band mode (associating the notification information with the carrier object through some mechanism).

Sending the notification information in an out-of-band mode includes: transmitting the notification information as a separate message, the notification information being associated with the carrier object.

In the in-band mode, the notification information needs to be embedded in the carrier object; and sending the notification information includes sending the carrier object.

It should be noted that, when the notification information is sent in the in-band mode, the notification information may include: identification information that indicates whether hidden information has been embedded in the carrier object; a type of embedded hidden information; description information of the embedded hidden information; a starting position wherein the embedded hidden information is embedded in the carrier object, used for distinguishing between the notification message and a data body of the carrier object, in order to prevent an occurrence of an erroneous extraction when the carrier object has no hidden information embedded.

When the out-of-band mode is used to send the notification information, two cases exist.

One case refers to sending only one carrier object. Since the notification information is sent normally after the hidden information is embedded in the carrier object, it can be considered that hidden information has been embedded upon receiving the notification information. The notification information may not include identification information indicating whether the hidden information has been embedded in the carrier object. The notification information may include: a type of the embedded hidden information; and description information of the embedded hidden information.

Another case refers to sending multiple carrier objects simultaneously, and includes the following approaches. The first approach may include sending individual notification information separately for each carrier object, where the individual notification information may not include identification information indicating whether hidden information has been embedded in the respective carrier object, and the notification information may include a type of embedded hidden information, and description information of the embedded hidden information. The second approach is to send single notification information for multiple carrier objects, where the notification information needs to include identification information used for indicating whether hidden information has been embedded in the carrier object, or used for indicating whether hidden information has been embedded in each carrier object. The notification information may also not include identification information used for indicating whether hidden information has been embedded in the carrier object. Whether the notification information needs to include identification information used for indicating whether hidden information has been embedded in the carrier object depends on whether the multiple carrier objects that are simultaneously transmitted are embedded with the hidden information. If the multiple carrier objects that are simultaneously transmitted are embedded with the hidden information, the notification information may not include identification information used for indicating whether the hidden information has been embedded in the carrier object, and the notification information may include a type of the embedded hidden information and description information of the embedded hidden information. If the multiple carrier objects includes a carrier object that does not have hidden information embedded therein and a carrier object that has hidden information embedded therein, the notification information needs to include identification information used for indicating whether hidden information has been embedded in a carrier object. The notification information may further include a type of embedded hidden information and description information of the embedded hidden information. For example, if there are 3 carrier objects, carrier object 1 and carrier object 3 have embedded hidden information, and carrier object 2 does not have embedded hidden information, notification information needs to include identification information used for indicating whether hidden information has been embedded in a carrier object. If there are 3 carrier objects, carrier object 1, carrier object 2, and carrier object 3 all have embedded hidden information, notification information may not include identification information used for indicating whether hidden information has been embedded in a carrier object.

When the notification information is embedded in the carrier object, the notification information in a binary data format or the notification information in a hexadecimal data format may be embedded in the carrier object.

It should be noted that, in a specific implementation, an in-band mode (embedding indication information together with the hidden information in the carrier object) and an out-of-band mode (associating the notification information with the carrier object using a certain mechanism) may be used at the same time when the notification information is sent. use of Using these two types of modes simultaneously can increase robustness.

So far, implementations of the information providing method provided by the first embodiment of the present disclosure have been described in detail. By generating and transmitting notification information for embedded hidden information in a carrier object, the first embodiment of the present disclosure solves the problem of potentially destroying embedded hidden information when hidden information is entered in cases of multi-level and/or multi-channel information hiding.

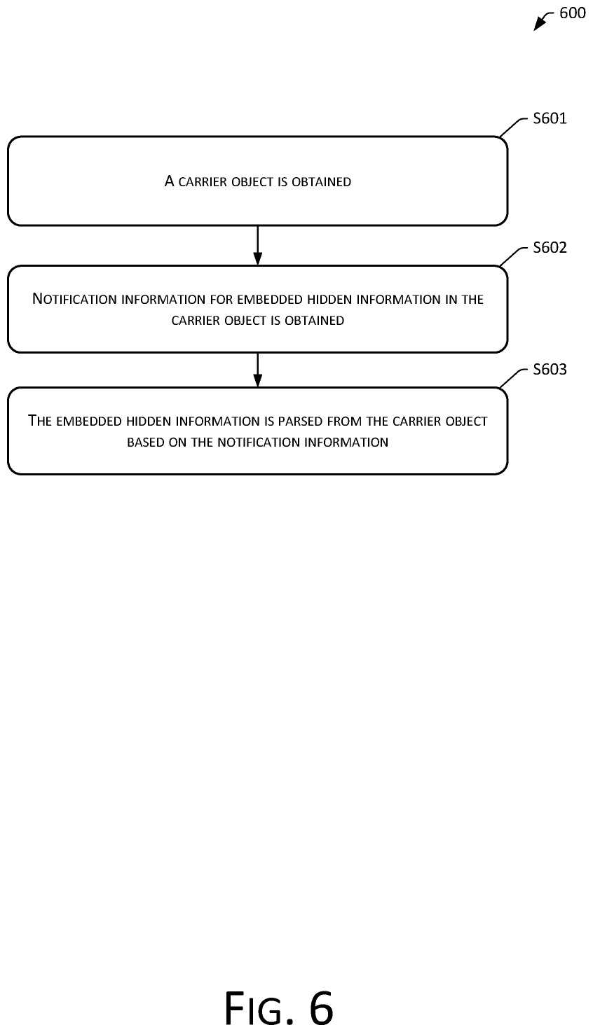

A second embodiment of the present disclosure provides a method for parsing hidden information. A subject of the second embodiment of the present disclosure is a hidden information parsing end (which may be the second information embedding end or the receiving end of the first embodiment). A detailed description of a method 600 for parsing hidden information is given hereinafter with reference to FIG. 6.

As shown in FIG. 6, at operation S601, a carrier object is obtained.

The carrier object refers to a carrier object that has embedded hidden information.

As shown in FIG. 6, at operation S602, notification information for embedded hidden information in the carrier object is obtained, the notification information being used for indicate to a hidden information parsing end to parse attributes of all the embedded hidden information in the carrier object, and embed new hidden information is embedded according to the attributes, without modifying the embedded hidden information.

The hidden information refers to additional information added to the carrier object. The additional information has a specific meaning. The carrier object may be a word document, a PDF document, an Excel file, etc. Adding appropriate hidden information into the carrier object can prevent data leakage and protect data security. For example, adding copyright information as a watermark in a word document can prevent piracy. The hidden information includes a digital watermark. The embedded hidden information is embedded digital watermark information, and the new hidden information is new digital watermark information.

The notification information includes hidden information metadata. The hidden information metadata is used to describe attribute(s) of the embedded hidden information.

The hidden information metadata includes at least one of the following types: a type of the embedded hidden information, an order in which the embedded hidden information is embedded in the carrier object, a level of the embedded hidden information, and an amount of the embedded hidden information, and description information of the embedded hidden information.

The order in which the embedded hidden information is embedded in the carrier object may be referred to as an access version of the hidden information. If the number of versions is no more than 16, an access version of hidden information may be represented by four bits. An initial version of hidden information is 0000. For example, if two embedding of hidden information has been performed before the embedded hidden information, an access version of the embedded hidden information is 3, and is denoted as 0011.

The type of the embedded hidden information includes at least one of the following types: a copyright type of hidden information; a digital type of hidden information; a structural type of hidden information; and a label type of hidden information.

Different service scenarios adapt to different types of hidden information, which specifically include copyright watermarks, digital fingerprints, authentication watermarks, security labeling watermarks, etc. A copyright watermark is mainly used for copyright protection of digital media. A digital fingerprint is mainly used for traceability issues in a data flow topology. If the number of watermark types is at most 8, 8 bits can then be used to indicate whether it is such a type. A plurality of watermark types can be simultaneously included in a single carrier object.

The notification information may include a level and an amount of the embedded hidden information. If the watermark type is digital fingerprint multi-level information hiding, multiple levels of hidden information have been embedded the carrier object when the carrier object is transmitted to a current node. In order to enable traceability of the hidden information, these pieces of hidden information need to be embedded in an order of access. Therefore, the upper level is also very important information. If the watermark type is a copyright watermark and the carrier object may have multiple pieces of copyright information, these pieces of information are of a same level if having the same author. If the copyright information has an order of sequence, these pieces of information are similar to the digital fingerprint multi-level watermark, having distinct levels.

The description information of the embedded hidden information may include length information of the embedded hidden information, information of a channel in which the embedded hidden information is embedded in the carrier object, embedding end identification information of the embedded hidden information, a number of times that the embedded hidden information is redundantly embedded in the channel, etc.

The length information of the embedded hidden information may be the number of bits included in the embedded hidden information after the embedded hidden information is encoded. For example, the embedded hidden information is a bit sequence of “0111101100”, and the length of the embedded hidden information is 10 bits.

Obtaining the notification information for the embedded hidden information in the carrier object includes:

obtaining the notification information that exists as a separate message; or

extracting the notification information from the carrier object.

Obtaining the notification information for the embedded hidden information in the carrier object includes:

obtaining the notification information in a binary data format for the embedded hidden information in the carrier object; or

obtaining the notification information in a hexadecimal data format for the embedded hidden information in the carrier object.

As shown in FIG. 6, at operation S603, the embedded hidden information is parsed from the carrier object based on the notification information.

In order to prevent an erroneous extraction of hidden information, a determination may first be made as to whether embedded hidden information exists in the carrier object. If affirmative, the embedded hidden information is parsed from the carrier object based on the notification information.

And parsing the embedded hidden information from the carrier object based on the notification information includes:

converting the notification information in a hexadecimal data format into notification information in a binary data format;

parsing the embedded hidden information from the carrier object according to the notification information in the binary data format.

When the notification information obtained at operation S602 is in a hexadecimal data format, the notification information is first converted into notification information in a binary data format, and the embedded hidden information is parsed from the carrier object.

Parsing the embedded hidden information from the carrier object based on the notification information includes:

parsing the hidden information from the carrier object based on description information of the embedded hidden information.

A process of parsing the embedded hidden information from the carrier object is still described using the example of the first embodiment of the present disclosure.

Notification information obtained by a hidden information extracting end is notification information in a hexadecimal data format:

“000132100002412340000000000000”, which is first converted to notification information in a binary data format:

“0000∥0000∥0000∥0001∥0∥011001000∥01000000∥0000∥000000∥001010∥0100∥0001∥0010∥0011∥0100∥0000000000000000∥000∥000000000000000000000 00000000000∥00000”.

1) The notification information of the above binary data format is parsed.

a) The starting prefix is “0101110101110101110101”.

b) The next 3 bits are “000”, and a capacity type that is obtained is no upper limit for a document embedding capacity.

c) The next 9 bits, the length of this information is 200;

d) The next 8 bits are “01000000”, and a type of hidden information that is embedded is known to be a digital fingerprint watermark by looking up Table 1.

e) The next 4 bits represent an order in which the embedded hidden information is embedded in the carrier object, and “0000” represents that an order of embedding is zero.

f) The next 6 bits are “000000”, which represent that the current embedding level is 0, and the current user is the first user to access the carrier.

g) The next 6 bits are “001010”, and a determination can be made that the embedded hidden information is 10 bits.

h) From the next 4 bits “0100”, a determination can be made that a total of 4 channels are used.

i) From the next 16 bits “0001001000110100”, a determination can be made that the first 4 channels are used.

j) From the next 16 bits “0000000000000000”, a determination can be made that it is embedding end identification information of the embedded hidden information.

k) From the next 3 bits “000”, a determination can be made that the number of times that the hidden information is redundantly embedded in each channel is 0.

I) A verification code is obtained from the last 32 bits, and a verification is performed on previous data.

2) According to the “description information of the embedded hidden information” obtained in 1), hidden information that is actually embedded is extracted in a plurality of channels: “0111101100”, “0111101100”, and “0111101100”.

On the basis of 2), redundancy is removed from the hidden information that is obtained from the multiple channels, and the hidden information “0111101100” that is actually embedded is obtained after the redundancy is removed.

So far, implementations of the method for parsing hidden information provided by the second embodiment of the present disclosure have been described in detail. The second embodiment of the present disclosure first obtains notification information for embedded hidden information, and then extracts the hidden information from a carrier object based on the notification information for the embedded hidden information. Since the hidden information is extracted from the carrier object based on the notification information for the embedded hidden information, the hidden information embedded in the carrier object can be accurately parsed.

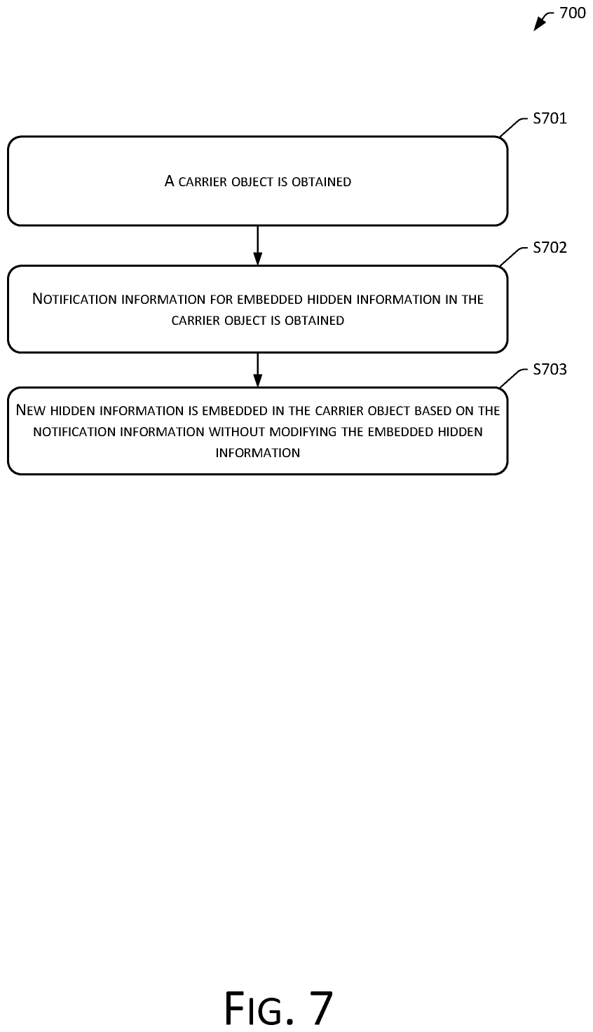

A third embodiment of the present disclosure provides a method 700 for embedding hidden information, which is described hereinafter with reference to FIG. 7.

As shown in FIG. 7, at operation S701, a carrier object is obtained.

The carrier object refers to a carrier object that has embedded hidden information.

As shown in FIG. 7, at operation S702, notification information for embedded hidden information in the carrier object is obtained, the notification information being used for indicating a hidden information embedding end to parse attributes of all the embedded hidden information in the carrier object, and embed new hidden information according to the attributes, without modifying the embedded hidden information.

The hidden information refers to additional information added to the carrier object. The additional information has a specific meaning. The carrier object may be a word document, a PDF document, an Excel file, etc. Adding appropriate hidden information into the carrier object can prevent data leakage and protect data security. For example, adding copyright information as a watermark in a word document can prevent piracy. The hidden information includes a digital watermark. The embedded hidden information is embedded digital watermark information, and the new hidden information is new digital watermark information.

The notification information includes hidden information metadata. The hidden information metadata is used to describe attribute(s) of the embedded hidden information.

The hidden information metadata includes at least one of the following types: a type of the embedded hidden information, an order in which the embedded hidden information is embedded in the carrier object, a level of the embedded hidden information, and an amount of the embedded hidden information, and description information of the embedded hidden information.

The order in which the embedded hidden information is embedded in the carrier object may be referred to as an access version of the hidden information. If the number of versions is no more than 16, an access version of hidden information may be represented by four bits. An initial version of hidden information is 0000. For example, if two embedding of hidden information has been performed before the embedded hidden information, an access version of the embedded hidden information is 3, and is denoted as 0011.

The type of the embedded hidden information includes at least one of the following types: a copyright type of hidden information; a digital type of hidden information; a structural type of hidden information; and a label type of hidden information.

Different service scenarios adapt to different types of hidden information, which specifically include copyright watermarks, digital fingerprints, authentication watermarks, security labeling watermarks, etc. A copyright watermark is mainly used for copyright protection of digital media. A digital fingerprint is mainly used for traceability issues in a data flow topology. If the number of watermark types is at most 8, 8 bits can then be used to indicate whether it is such a type. A plurality of watermark types can be simultaneously included in a single carrier object.

The notification information may include a level and an amount of the embedded hidden information. If the watermark type is digital fingerprint multi-level information hiding, multiple levels of hidden information have been embedded the carrier object when the carrier object is transmitted to a current node. In order to enable traceability of the hidden information, these pieces of hidden information need to be embedded in an order of access. Therefore, the upper level is also very important information. If the watermark type is a copyright watermark and the carrier object may have multiple pieces of copyright information, these pieces of information are of a same level if having the same author. If the copyright information has an order of sequence, these pieces of information are similar to the digital fingerprint multi-level watermark, having distinct levels.

The description information of the embedded hidden information may include length information of the embedded hidden information, information of a channel in which the embedded hidden information is embedded in the carrier object, embedding end identification information of the embedded hidden information, a number of times that the embedded hidden information is redundantly embedded in the channel, etc.

The length information of the embedded hidden information may be the number of bits included in the embedded hidden information after the embedded hidden information is encoded. For example, the embedded hidden information is a bit sequence of “0111101100”, and the length of the embedded hidden information is 10 bits.

Obtaining the notification information for the embedded hidden information in the carrier object includes:

obtaining information including the notification information; or

extracting the notification information from the carrier object.

Obtaining the notification information for the embedded hidden information in the carrier object includes:

obtaining notification information in a binary data format for the embedded hidden information in the carrier object; or

obtaining notification information in a hexadecimal data format for the embedded hidden information in the carrier object.

As shown in FIG. 7, at operation S703, new hidden information is embedded in the carrier object based on the notification information without modifying the embedded hidden information.

Embedding the new hidden information in the carrier object based on the notification information without modifying the embedded hidden information, includes:

determining a first location in which the embedded hidden information is embedded in the carrier object based on the notification information; and

embedding the new hidden information in a second location in the carrier object that is different from the first location.

Embedding the new hidden information in the carrier object based on the notification information without modifying the embedded hidden information, includes:

determining a first channel used by the embedded hidden information when being embedded in the carrier object based on the notification information; and

embedding the new hidden information in the carrier object by a second channel that is different from the first channel.

Embedding the new hidden information into the second location that is different from the first location or embedding the new hidden information into the carrier object through the second channel that is different from the first channel prevents the new hidden information from destroying the embedded hidden information in the carrier object.

Corresponding to an information processing method provided by the first embodiment of the present disclosure, a fourth embodiment of the present disclosure further provides an information processing apparatus.

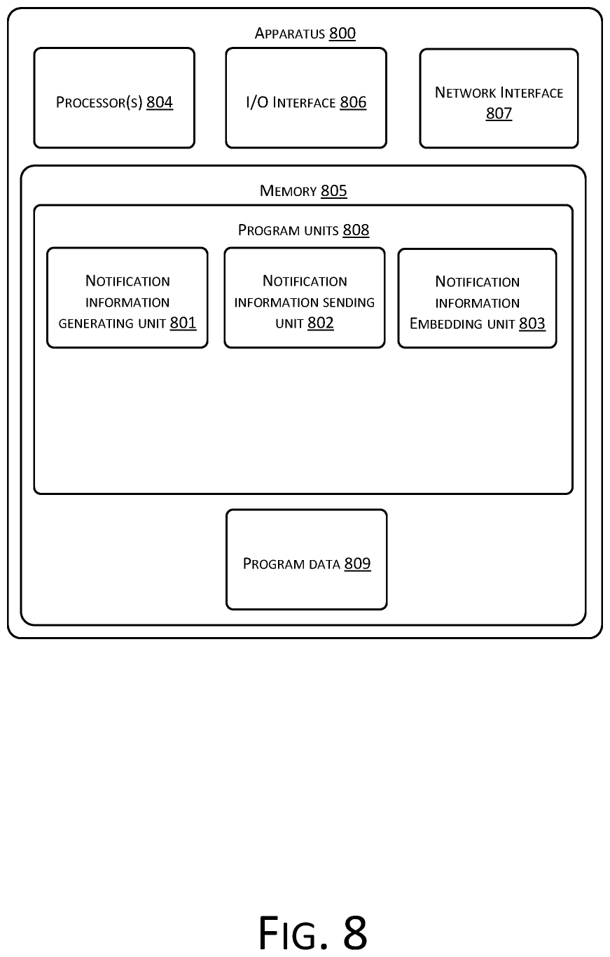

As shown in FIG. 8, the information processing apparatus 800 is applied in a first information embedding end, and includes:

a notification information generating unit 801 configured to generate notification information for embedded hidden information in a carrier object, the notification information being used for indicating a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

a notification information sending unit 802 configured to send the notification information.

In implementations, the notification information sending unit 802 is specifically configured to the notification information as a separate message, the notification information being associated with the carrier object.

In implementations, one carrier object is included, and the notification information includes:

a type of the embedded hidden information; and

description information of the embedded hidden information.

In implementations, at least two carrier objects are included, and the notification information sending unit is specifically configured to send a separate piece of notification information to each carrier object, the notification information including a type of the embedded hidden information, and description information of the embedded hidden information.

In implementations, the at least two carrier objects are included, and the notification information sending unit is specifically configured to send a single piece of notification information to the at least two carrier objects.

In implementations, when multiple carrier objects that are simultaneously sent are embedded with hidden information, the notification information includes:

a type of the embedded hidden information; and

description information of the embedded hidden information.

In implementations, when multiple carrier objects that are simultaneously sent include both a carrier object that is not embedded with hidden information and a carrier object that is embedded with hidden information, the notification information includes:

identification information that is used for indicating whether hidden information has been embedded in the carrier object;

a type of the embedded hidden information; and

description information of the embedded hidden information.

In implementations, the apparatus 800 further includes a notification information embedding unit 803 that embeds the notification information into the carrier object, wherein the notification information sending unit is specifically configured to send the carrier object.

In implementations, the notification information includes:

identification information that is used for indicating whether hidden information has been embedded in the carrier object;

a type of the embedded hidden information; and

description information of the embedded hidden information.

In implementations, the notification information embedding unit 803 is further configured to embed the notification information into the carrier object, wherein the notification information sending unit is specifically configured to send the carrier object.

In implementations, the notification information includes hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information;

description information of the embedded hidden information.

In implementations, the type of the embedded hidden information includes at least one of the following types:

a copyright type of hidden information;

a numerical type of hidden information;

a structural type of hidden information; and

an annotation type of hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, the notification information further includes at least one of the following information:

starting prefix information, the starting prefix information being used for indicating whether hidden information has been embedded in the carrier object or used for marking a starting position of at where the embedded hidden information is embedded in the carrier object;

a capacity type of hidden information that can be embedded;

length information of hidden information metadata;

verification information for the notification information.

In implementations, the capacity type is determined according to a file type of the carrier object.

In implementations, the notification information sending unit 802 is specifically configured to embed notification information in a binary data format or notification information in a hexadecimal data format into the carrier object.

In implementations, the embedded hidden information is embedded digital watermark information, and the new hidden information is new digital watermark information.

In implementations, the apparatus 800 may further include one or more processors 804, memory 805, an input/output (I/O) interface 806, and a network interface 807.

The memory 805 may include a form of computer readable media such as a volatile memory, a random access memory (RAM) and/or a non-volatile memory, for example, a read-only memory (ROM) or a flash RAM. The memory 805 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 805 may include program units 808 and program data 809. The program units 808 may include one or more units as described in the foregoing description and shown in FIG. 8.

It should be noted that a detailed description of the information processing apparatus provided in the fourth embodiment of the present disclosure can be referenced to relevant descriptions of the first embodiment of the present disclosure, and details thereof are not repeatedly described herein.

A fifth embodiment of the present disclosure further provides an electronic device, which corresponds to the information processing method provided by the first embodiment of the present disclosure.

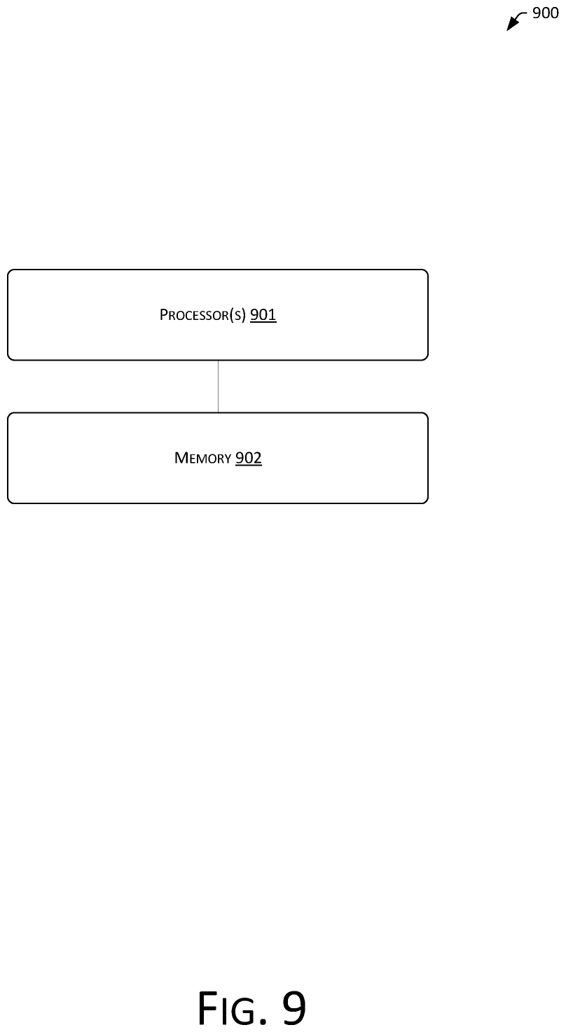

As shown in FIG. 9, an electronic device 900 includes:

processor(s) 901;

memory 902 configured to store a program of an information processing method, wherein the device, after being powered on and running the program of the information processing method through the processor(s), performs the following operations:

generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

sending the notification information.

In implementations, sending the notification information includes transmitting the notification information as a separate message, the notification information being associated with the carrier object.

In implementations, one carrier object is included, and the notification information includes:

a type of the embedded hidden information; and

description information of the embedded hidden information.

In implementations, at least two carrier objects are included, and sending the notification information includes: sending a separate piece of notification information to each carrier object, the notification information including a type of the embedded hidden information, and description information of the embedded hidden information.

In implementations, the at least two carrier objects are included, and sending the notification information includes sending a single piece of notification information to the at least two carrier objects.

In implementations, when multiple carrier objects that are simultaneously sent are embedded with hidden information, the notification information includes:

a type of the embedded hidden information; and

description information of the embedded hidden information.

In implementations, when multiple carrier objects that are simultaneously sent include both a carrier object that is not embedded with hidden information and a carrier object that is embedded with hidden information, the notification information includes:

identification information that is used for indicating whether hidden information has been embedded in the carrier object;

a type of the embedded hidden information; and

description information of the embedded hidden information.

In implementations, the method further includes: embedding the notification information into the carrier object, wherein sending the notification information includes sending the carrier object.

In implementations, the notification information includes:

identification information that is used for indicating whether hidden information has been embedded in the carrier object;

a type of the embedded hidden information; and

description information of the embedded hidden information.

In implementations, the notification information includes hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information;

description information of the embedded hidden information.

In implementations, the type of the embedded hidden information includes at least one of the following types:

a copyright type of hidden information;

a numerical type of hidden information;

a structural type of hidden information; and

an annotation type of hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, the notification information further includes at least one of the following information:

starting prefix information, the starting prefix information being used for indicating whether hidden information has been embedded in the carrier object or used for marking a starting position of at where the embedded hidden information is embedded in the carrier object;

a capacity type of hidden information that can be embedded;

length information of hidden information metadata;

verification information for the notification information.

In implementations, the capacity type is determined according to a file type of the carrier object.

In implementations, embedding the notification information into the carrier object includes:

embedding notification information in a binary data format or notification information in a hexadecimal data format into the carrier object.

In implementations, the embedded hidden information is embedded digital watermark information, and the new hidden information is new digital watermark information.

It should be noted that a detailed description of the electronic device provided in the fifth embodiment of the present disclosure can be referenced to relevant descriptions of the first embodiment of the present disclosure, and details thereof are not repeatedly described herein.

Corresponding to the information processing method provided by the first embodiment of the present disclosure, a sixth embodiment of the present disclosure further provides a storage device that stores a program of an information processing method, the program being executed by a processor to perform the following operations:

generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and

sending the notification information.

It should be noted that a detailed description of the storage device provided in the sixth embodiment of the present disclosure can be referenced to relevant descriptions of the first embodiment of the present disclosure, and details thereof are not repeatedly described herein.

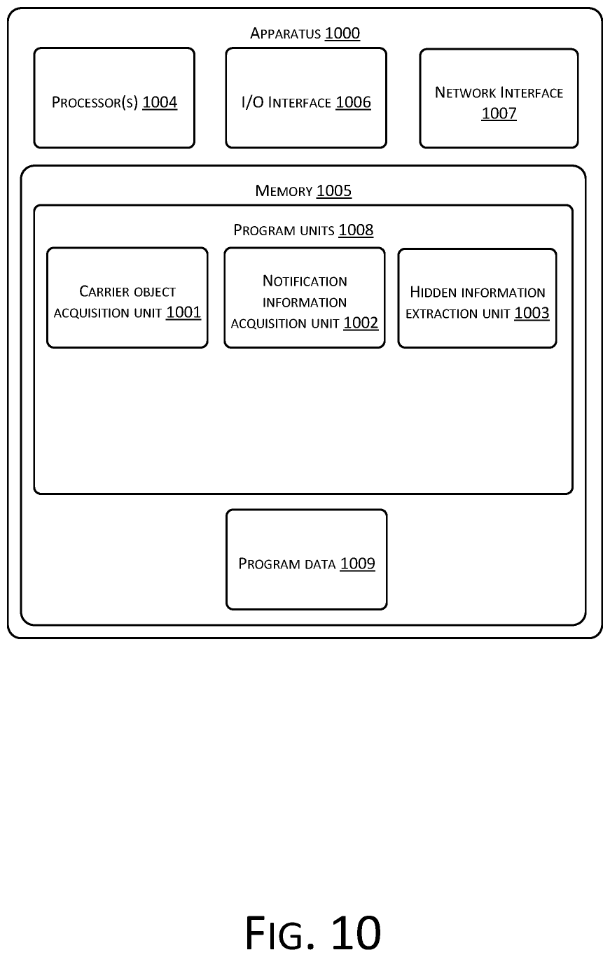

Corresponding to the method for parsing hidden information provided by the second embodiment of the present disclosure, a seventh embodiment of the present disclosure further provides an apparatus 1000 for parsing hidden information as shown in FIG. 10.

As shown in FIG. 10, the apparatus 1000 includes:

a carrier object acquisition unit 1001 configured to obtain a carrier object;

a notification information acquisition unit 1002 configured to obtain notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

a hidden information extraction unit 1003 configured to parse the embedded hidden information from the carrier object based on the notification information.

In implementations, the notification information acquisition unit 1002 is specifically configured to obtain the notification information that exists as a separate message; or extract the notification information from the carrier object.

In implementations, the hidden information extraction unit 1003 is specifically configured to convert notification information in a hexadecimal data format into notification information in a binary data format; and parse the embedded hidden information from the carrier object according to the notification information in the binary data format.

In implementations, the notification information includes: hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information; and

description information of the embedded hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, the hidden information extraction unit 1003 is specifically configured to parse the hidden information from the carrier object based on description information of the embedded hidden information.

In implementations, the apparatus 1000 may further include one or more processors 1004, memory 1005, an input/output (I/O) interface 1006, and a network interface 1007. The memory 1005 may include a form of computer readable media as described in the foregoing description. In implementations, the memory 1005 may include program units 1008 and program data 1009. The program units 1008 may include one or more modules as described in the foregoing description and shown in FIG. 10.

It should be noted that a detailed description of the apparatus provided in the seventh embodiment of the present disclosure can be referenced to relevant descriptions of the first embodiment of the present disclosure, and details thereof are not repeatedly described herein.

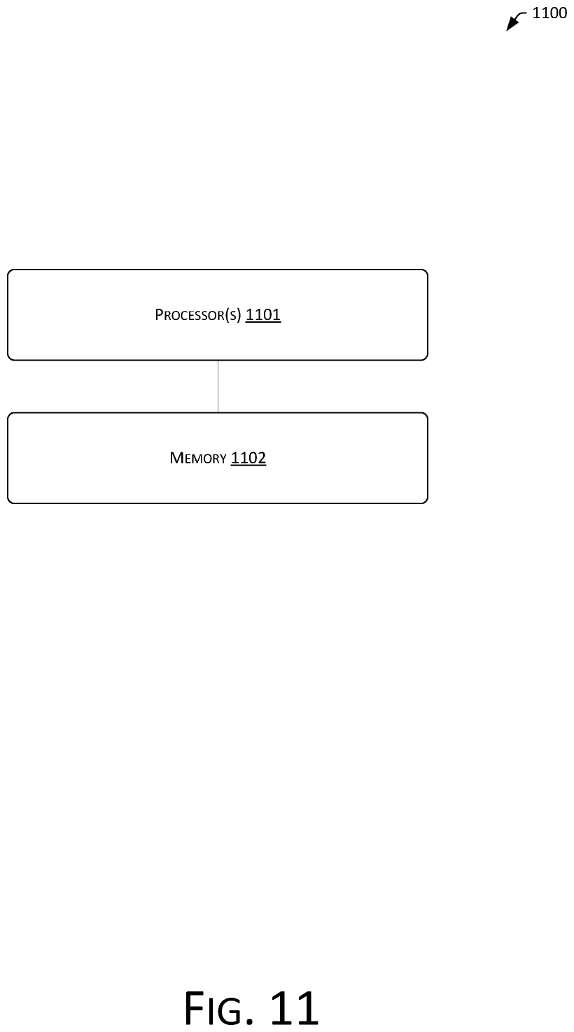

Corresponding to the method for parsing hidden information provided by the second embodiment of the present disclosure, an eighth embodiment of the present disclosure further provides an electronic device 1100 as shown in FIG. 11.

As shown in FIG. 11, the electronic device 1100 includes:

processor(s) 1101;

memory 1102 configured to store a program of a hidden information parsing method, wherein the device, after being powered on and running the program of the information processing method through the processor(s), performs the following operations:

obtaining a carrier object;

obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

In implementations, obtaining the notification information for the embedded hidden information in the carrier object includes:

obtaining the notification information that exists as a separate message; or

extracting the notification information from the carrier object.

In implementations, parsing the embedded hidden information from the carrier object based on the notification information includes:

converting notification information in a hexadecimal data format into notification information in a binary data format; and

parsing the embedded hidden information from the carrier object according to the notification information in the binary data format.

In implementations, the notification information includes: hidden information metadata, the hidden information metadata being used for describing the attributes of the embedded hidden information.

In implementations, the hidden information metadata includes at least one of the following information:

a type of the embedded hidden information;

an order in which the embedded hidden information is embedded in the carrier object;

a level of the embedded hidden information;

an amount of the embedded hidden information; and

description information of the embedded hidden information.

In implementations, the description information of the embedded hidden information includes at least one of the following information:

length information of the embedded hidden information;

information of a channel in which the embedded hidden information is embedded in the carrier object;

embedding end identification information of the embedded hidden information; and

a number of times that the embedded hidden information is redundantly embedded in the channel.

In implementations, parsing the embedded hidden information from the carrier object based on the notification information includes:

parsing the hidden information from the carrier object based on description information of the embedded hidden information.

It should be noted that a detailed description of the electronic device provided in the eighth embodiment of the present disclosure can be referenced to relevant descriptions of the second embodiment of the present disclosure, and details thereof are not repeatedly described herein.

Corresponding to the method for extracting hidden information provided by the second embodiment of the present disclosure, a ninth embodiment of the present disclosure further provides a storage device that stores a program of a hidden information parsing method, the program being executed by a processor to perform the following operations:

obtaining a carrier object;

obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

It should be noted that a detailed description of the electronic device provided in the ninth embodiment of the present disclosure can be referenced to relevant descriptions of the second embodiment of the present disclosure, and details thereof are not repeatedly described herein.

Although the present disclosure is disclosed using the preferred embodiments as above, they are not intended to limit the present disclosure. One person skilled in the art can make possible changes and modifications without departing from the spirit and scope of the present disclosure. Therefore, the scope of protection of the present disclosure shall be based on the scope defined by the claims of the present disclosure.

In a typical configuration, a computing device includes one or more processors (CPUs), an input/output interface, a network interface, and memory.

The memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

One skilled in the art should understand that the embodiments of the present disclosure can be provided as a method, a system, or a computer program product. Thus, the present disclosure can take a form of an entirely hardware embodiment, an entirely software embodiment or an embodiment of a combination of software and hardware. Moreover, the present disclosure can take a form of a computer program product embodied on one or more computer-usable storage media (which includes, but is not limited to a magnetic disk, CD-ROM, an optical storage device, etc.) that includes computer usable program codes.

The present disclosure can be further understood using the following clauses.

Clause 1: An information processing method, which is applied in a first information embedding end, the method comprising: generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and sending the notification information.

Clause 2: The method of Clause 1, wherein sending the notification information comprises transmitting the notification information as a separate message, the notification information being associated with the carrier object.

Clause 3: The method of Clause 2, wherein the carrier object comprises one carrier object, and the notification information comprises: a type of the embedded hidden information; and description information of the embedded hidden information.

Clause 4: The method of Clause 2, wherein the carrier object comprises at least two carrier objects, and sending the notification information comprises sending a separate piece of notification information to each carrier object, the notification information including a type of the embedded hidden information, and description information of the embedded hidden information.

Clause 5: The method of Clause 2, wherein the carrier object comprises at least two carrier objects, and sending the notification information comprises sending a single piece of notification information to the at least two carrier objects.

Clause 6: The method of Clause 5, wherein: when multiple carrier objects that are simultaneously sent are embedded with hidden information, the notification information comprises: a type of the embedded hidden information; and description information of the embedded hidden information.

Clause 7: The method of Clause 5, wherein: when multiple carrier objects that are simultaneously sent comprise both a carrier object that is not embedded with hidden information and a carrier object that is embedded with hidden information, and the notification information comprises: identification information that is used for indicating whether hidden information has been embedded in the carrier object; a type of the embedded hidden information; and description information of the embedded hidden information.

Clause 8: The method of Clause 1, comprising embedding the notification information into the carrier object, wherein sending the notification information includes sending the carrier object.

Clause 9: The method of Clause 8, wherein the notification information comprises: identification information that is used for indicating whether hidden information has been embedded in the carrier object; a type of the embedded hidden information; and

description information of the embedded hidden information.

Clause 10: The method of Clause 1, wherein the notification information comprises hidden information metadata, the hidden information metadata being used for describing the attributes of the embedded hidden information.

Clause 11: The method of Clause 10, wherein the hidden information metadata comprises at least one of the following information: a type of the embedded hidden information; an order in which the embedded hidden information is embedded in the carrier object; a level of the embedded hidden information; an amount of the embedded hidden information; and description information of the embedded hidden information.

Clause 12: The method of Clause 11, wherein the type of the embedded hidden information comprises at least one of the following types: a copyright type of hidden information; a numerical type of hidden information; a structural type of hidden information; and an annotation type of hidden information.

Clause 13: The method of Clause 11, wherein the description information of the embedded hidden information comprises at least one of the following information: length information of the embedded hidden information; information of a channel in which the embedded hidden information is embedded in the carrier object; embedding end identification information of the embedded hidden information; and a number of times that the embedded hidden information is redundantly embedded in the channel.

Clause 14: The method of Clause 1, wherein the notification information further comprises at least one of the following information: starting prefix information, the starting prefix information being used for indicating whether hidden information has been embedded in the carrier object or used for marking a starting position of at where the embedded hidden information is embedded in the carrier object; a capacity type of hidden information that can be embedded; length information of hidden information metadata; and verification information for the notification information.

Clause 15: The method of Clause 14, wherein the capacity type is determined according to a file type of the carrier object.

Clause 16: The method of Clause 8, wherein embedding the notification information into the carrier object comprises: embedding notification information in a binary data format or notification information in a hexadecimal data format into the carrier object.

Clause 17: The method of any one of Clauses 1-16, wherein the embedded hidden information is embedded digital watermark information, and the new hidden information is new digital watermark information.

Clause 18: A method for parsing hidden information, comprising: obtaining a carrier object; obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and

parsing the embedded hidden information from the carrier object based on the notification information.

Clause 19: The method of Clause 18, wherein parsing the embedded hidden information from the carrier object based on the notification information comprises: determining whether embedded hidden information exists in the carrier object; and parsing the embedded hidden information is parsed from the carrier object based on the notification information if affirmative.

Clause 20: The method of Clause 18, wherein obtaining the notification information for the embedded hidden information in the carrier object comprises: obtaining the notification information that exists as a separate message; or extracting the notification information from the carrier object.

Clause 21: The method of Clause 18, wherein parsing the embedded hidden information from the carrier object based on the notification information comprises: converting notification information in a hexadecimal data format into notification information in a binary data format; and parsing the embedded hidden information from the carrier object according to the notification information in the binary data format.

Clause 22: The method of Clause 18, wherein the notification information comprises hidden information metadata, the hidden information metadata being used for describing the attributes of the embedded hidden information.

Clause 23: The method of Clause 22, wherein the hidden information metadata comprises at least one of the following information: a type of the embedded hidden information; an order in which the embedded hidden information is embedded in the carrier object; a level of the embedded hidden information; an amount of the embedded hidden information; and description information of the embedded hidden information.

Clause 24: The method of Clause 23, wherein the description information of the embedded hidden information comprises at least one of the following information: length information of the embedded hidden information; information of a channel in which the embedded hidden information is embedded in the carrier object; embedding end identification information of the embedded hidden information; and a number of times that the embedded hidden information is redundantly embedded in the channel.

Clause 25: The method of Clause 23, wherein parsing the embedded hidden information from the carrier object based on the notification information comprises: parsing the hidden information from the carrier object based on description information of the embedded hidden information.

Clause 26: A method for embedding hidden information, comprising: obtaining a carrier object; obtaining notification information for embedded hidden information in the carrier object, the notification information being used for instructing a hidden information embedding end to parse attributes of all the embedded hidden information in the carrier object, and embed new hidden information according to the attributes, without modifying the embedded hidden information; and embedding the new hidden information in the carrier object without modifying the embedded hidden information based on the notification information.

Clause 27: The method of Clause 26, wherein embedding the new hidden information in the carrier object without modifying the embedded hidden information based on the notification information comprises: determining a first location in which the embedded hidden information is embedded in the carrier object based on the notification information; and embedding the new hidden information in a second location of the carrier object that is different from the first location.

Clause 28: The method of Clause 26, wherein embedding the new hidden information in the carrier object without modifying the embedded hidden information based on the notification information comprises: determining a first channel used by the embedded hidden information when being embedded in the carrier object based on the notification information; and embedding the new hidden information in the carrier object through a second channel that is different from the first channel.

Clause 29: An information processing apparatus, which is applied in a first information embedding end, comprising: a notification information generating unit configured to generate notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and a notification information sending unit configured to send the notification information.

Clause 30: An electronic device, comprising: a processor; memory configured to store a program of an information processing method, wherein the device, after being powered on and running the program of the information processing method through the processor, performs the following operations: generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and sending the notification information.

Clause 31: A storage device that stores a program of an information processing method, the program being executed by a processor to perform the following operations: generating notification information for embedded hidden information in a carrier object, the notification information being used for instructing a receiving end to parse attributes of all the embedded hidden information in the carrier object, or being used for instructing a second information embedding end to parse the attributes of all the embedded hidden information in the carrier object, and embed new hidden information based on the attributes, without modifying the embedded hidden information; and sending the notification information.

Clause 32: An apparatus for parsing hiding information, comprising: a carrier object acquisition unit configured to obtain a carrier object; a notification information acquisition unit configured to obtain notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and a hidden information extraction unit configured to parse the embedded hidden information from the carrier object based on the notification information.

Clause 33: An electronic device, comprising: a processor; memory configured to store a program of a hidden information parsing method, wherein the device, after being powered on and running the program of the information processing method through the processor, performs the following operations: obtaining a carrier object; obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and parsing the embedded hidden information from the carrier object based on the notification information.

Clause 34: A storage device that stores a program of a hidden information parsing method, the program being executed by a processor to perform the following operations: obtaining a carrier object; obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and parsing the embedded hidden information from the carrier object based on the notification information.

What is claimed is:

1. A method implemented by a computing device, the method comprising:
obtaining a carrier object;
obtaining notification information for embedded hidden information in the carrier object, the notification information being used for instructing a hidden information embedding end to parse attributes of at least a part of the embedded hidden information in the carrier object, and embed new hidden information according to the attributes, without modifying the embedded hidden information; and
embedding the new hidden information in the carrier object without modifying the embedded hidden information based on the notification information.

2. The method of claim 1, wherein embedding the new hidden information in the carrier object without modifying the embedded hidden information based on the notification information comprises:
determining a first location in which the embedded hidden information is embedded in the carrier object based on the notification information; and
embedding the new hidden information in a second location of the carrier object that is different from the first location.

3. The method of claim 1, wherein embedding the new hidden information in the carrier object without modifying the embedded hidden information based on the notification information comprises:
determining a first channel used by the embedded hidden information when being embedded in the carrier object based on the notification information;
embedding the new hidden information in the carrier object through a second channel that is different from the first channel.

4. The method of claim 1, further comprising parsing the embedded hidden information from the carrier object based on the notification information.

5. The method of claim 4, wherein parsing the embedded hidden information from the carrier object based on the notification information comprises:
determining whether embedded hidden information exists in the carrier object; and
parsing the embedded hidden information is parsed from the carrier object based on the notification information if affirmative.

6. The method of claim 4, wherein parsing the embedded hidden information from the carrier object based on the notification information comprises:
converting notification information in a hexadecimal data format into notification information in a binary data format; and
parsing the embedded hidden information from the carrier object according to the notification information in the binary data format.

7. The method of claim 1, wherein obtaining the notification information for the embedded hidden information in the carrier object comprises:
obtaining the notification information that exists as a separate message; or
extracting the notification information from the carrier object.

8. The method of claim 1, wherein the notification information comprises hidden information metadata, the hidden information metadata being used for describing the attributes of the embedded hidden information.

9. The method of claim 8, wherein the hidden information metadata comprises at least one of:
a type of the embedded hidden information;
an order in which the embedded hidden information is embedded in the carrier object;
a level of the embedded hidden information;
an amount of the embedded hidden information; and
description information of the embedded hidden information.

10. The method of claim 1, wherein the notification information further comprises at least one of:
starting prefix information, the starting prefix information being used for indicating whether hidden information has been embedded in the carrier object or used for marking a starting position of at where the embedded hidden information is embedded in the carrier object;
a capacity type of hidden information that is embeddable;
length information of hidden information metadata;
verification information for the notification information.

11. One or more computer readable media storing executable instructions that, when executed by one or more processors, cause the one or more processors to perform acts comprising:
obtaining a carrier object;
obtaining notification information for embedded hidden information in the carrier object, the notification information being used for indicating that the notification information is used to instruct a hidden information parsing end to parse attributes of all the embedded hidden information of the carrier object, and embed new hidden information according to the attributes, without modifying the embedded hidden information; and
parsing the embedded hidden information from the carrier object based on the notification information.

12. The one or more computer readable media of claim 11, wherein parsing the embedded hidden information from the carrier object based on the notification information comprises:
determining whether embedded hidden information exists in the carrier object; and
parsing the embedded hidden information is parsed from the carrier object based on the notification information if affirmative.

13. The one or more computer readable media of claim 11, wherein obtaining the notification information for the embedded hidden information in the carrier object comprises:
obtaining the notification information that exists as a separate message; or
extracting the notification information from the carrier object.

14. The one or more computer readable media of claim 11, wherein parsing the embedded hidden information from the carrier object based on the notification information comprises:
converting notification information in a hexadecimal data format into notification information in a binary data format; and
parsing the embedded hidden information from the carrier object according to the notification information in the binary data format.

15. The one or more computer readable media of claim 11, wherein the notification information comprises hidden information metadata, the hidden information metadata being used for describing the attributes of the embedded hidden information.

16. The one or more computer readable media of claim 15, wherein the hidden information metadata comprises at least one of:
a type of the embedded hidden information;
an order in which the embedded hidden information is embedded in the carrier object;
a level of the embedded hidden information;
an amount of the embedded hidden information; and
description information of the embedded hidden information.

17. The one or more computer readable media of claim 11, wherein the notification information further comprises at least one of:
starting prefix information, the starting prefix information being used for indicating whether hidden information has been embedded in the carrier object or used for marking a starting position of at where the embedded hidden information is embedded in the carrier object;
a capacity type of hidden information that is embeddable;
length information of hidden information metadata;
verification information for the notification information.

18. An apparatus comprising:
one or more processors;
memory storing executable instructions that, when executed by the one or more processors, cause the one or more processors to perform acts comprising:
obtaining a carrier object;
obtaining notification information for embedded hidden information in the carrier object, the notification information being used for instructing a hidden information embedding end to parse attributes of at least a part of the embedded hidden information in the carrier object, and embed new hidden information according to the attributes, without modifying the embedded hidden information; and
embedding the new hidden information in the carrier object without modifying the embedded hidden information based on the notification information.

19. The apparatus of claim 18, wherein embedding the new hidden information in the carrier object without modifying the embedded hidden information based on the notification information comprises:
determining a first location in which the embedded hidden information is embedded in the carrier object based on the notification information; and
embedding the new hidden information in a second location of the carrier object that is different from the first location.

20. The apparatus of claim 18, wherein embedding the new hidden information in the carrier object without modifying the embedded hidden information based on the notification information comprises:
determining a first channel used by the embedded hidden information when being embedded in the carrier object based on the notification information;
embedding the new hidden information in the carrier object through a second channel that is different from the first channel.
